(19) United States
(12) Patent Application Publication
(10) Pub. No.: US 2005/0210931 A1
(43) Pub. Date: Sep. 29, 2005

(54) Balancing fluid storage and delivery system for a washing machine

(76) Inventors: Vincent J. Contini, Powell, OH (US); Paul E. George II, Powell, OH (US); Troy A. Johnson, Newton, IA (US)

Correspondence Address: DIEDERIKS & WHITELAW, PLC, #301, 12471 Dillingham Square, Woodbridge, VA, 22192, US

(21) Appl. No.: 10/809,331

(22) Filed: Mar. 26, 2004

(51) Int. Cl. B08B 3/12

(52) U.S. Cl. 68/13 R; 68/23.1; 68/23 R; 68/19

(57) ABSTRACT

A washing machine includes an inner tub rotatably mounted within an outer tub having a rear wall portion and a main body portion. A balancing fluid reservoir is molded to an upper region of the main body portion of the outer tub. The reservoir includes an opening leading to a plurality of fluid delivery channels molded along the rear wall portion of the outer tub. Preferably two channels are molded into the outer tub for delivering the balancing fluid to the inner tub, and a third channel for returning the balancing fluid to the reservoir. A cover plate, having a pair of receiver openings for injector valves, is positioned to close off the first, second and third channels.

### BACKGROUND OF THE INVENTION

1. Field of the Invention

The present invention pertains to the art of washing machines and, more particularly, to a balancing fluid reservoir and delivery system for an out-of-balance control system provided to correct an out-of-balance condition of an inner tub of a washing machine.

2. Discussion of the Prior Art

During operation of a washing machine, it is not uncommon for an inner tub or spinner, which is rotatably mounted within the washing machine, to become unbalanced due to a particular distribution of a load of laundry. During the course of a typical wash cycle, the inner tub is rotated at a relatively high or extraction speed to extract water absorbed by the laundry. If the laundry is unevenly distributed within the inner tub during the extraction phase, an out-of-balance condition will develop. This out-of-balance condition, when rotated at the extraction speed, can cause excessive vibration.

Certainly, excessive vibration is detrimental to the continued operation and reliability of the machine. Accordingly, the prior art contains several examples of vibration or out-of balance detection systems for sensing an actual or incipient unbalance condition. In addition, it is known to correct the out-of-balance condition without interrupting operation of the washing machine even after exceeding a predetermined vibration threshold. In general, prior art systems function to reduce the rotational speed of the inner tub, provide a means of re-balancing the inner tub or, less desirably, entirely shut down the machine until a consumer corrects the problem by physically redistributing the laundry within the machine.

Systems for re-balancing an out-of-balance washing machine are well known in the prior art. Examples of such systems are described in U.S. Pat. Nos. 3,983,035 and 4,991,247. In each of these systems, the out-of-balance condition is corrected by injecting a balancing fluid into a container located on an inner peripheral portion of a rotating inner tub. Nozzles or other water inlets are adapted to rotate with the inner tub and, upon receiving a particular control signal, dispense a predetermined amount of balancing fluid into the container(s) which eventually counteracts the out-of-balance condition. The structure required to enable each nozzle to rotate with the inner tub, maintain a fluid connection between the nozzles and a central supply, and to provide a separate supply to each container requires a complicated arrangement of components which substantially increases the cost of the appliance. In addition, it has been found that systems which do not include containers for receiving the balancing fluid on both front and rear portions of the rotating tub require a larger amount of balancing fluid and, moreover, require a longer time period to facilitate correction of the unbalanced condition which could expose the appliance to unacceptable vibration levels.

In addition to the above, there exist a number of complications associated with delivering the balancing fluid to the containers. Specifically, complications exist with controlling the amount of fluid introduced into the containers. When using a pressurized system, precise control of the fluid is difficult to achieve. Namely, when the fluid column is under pressure, it is difficult to accurately control the amount of balancing fluid introduced into the containers. A valve is cycled rapidly and repeatedly to direct the balancing fluid into the rotating inner tub. Rapid opening and closing of the valve must both initially accelerate the balancing fluid and then subsequently stop the forward motion of the fluid stream. When the fluid is under pressure, i.e., when the fluid is brought up from a reservoir located below the container, stopping the forward motion of the fluid stream is often difficult. Once the valve is closed, the fluid develops a tail that extends from the valve until the cohesive bonds within the fluid stream break. This will result in either too much fluid being dispensed into the container or, alternatively, fluid being placed into the wrong container. In either case, correcting the unbalanced state becomes a more difficult and lengthy process.

While the above described systems for correcting an out-of-balance condition in a washing machine are effective to a degree, there still exists a need in the art for a system which will more efficiently correct an unbalanced condition by using a unpressurized fluid flow. Furthermore, there exists a need for an improved unbalance correction system which is simple in construction and operation, so as to be both reliable and cost effective.

### SUMMARY OF THE INVENTION

A washing machine constructed in accordance with the present invention incorporates a system for storing and delivering an un-pressurized balancing fluid to correct an out-of-balance condition. More specifically, the present invention is directed to a washing machine including an outer tub having a rear portion including inner and outer surfaces, a main body portion extending from the rear portion to a terminal rim, and an inner tub supported for rotational movement within the outer tub. In accordance with a preferred form of the invention, a balancing fluid reservoir is integrally molded to an upper surface of the main body portion. The reservoir includes a first or upper opening adapted to receive the balancing fluid and a second or lower opening adapted to dispense the balancing fluid.

A plurality of balancing fluid channels are integrally molded into the outer surface of the rear portion of the outer tub. Each of the channels includes a first end open to the fluid reservoir and a second end having a valve seat opening to an interior portion of the outer tub. In a preferred arrangement, the plurality of balancing fluid channels constitute first and second fluid delivery channels adapted to conduct fluid from the reservoir, and a third or fluid return channel that partially defines a return path to the reservoir. Each of the plurality of channels is separated by a respective raised wall portions and, preferably between the first and second channels, a double wall portion. The plurality of channels are closed off by a cover plate secured to the raised wall portions. More specifically, the cover plate includes first and second cylindrical receiver openings for securing injector valves relative to the first and second channels. With this arrangement, the valves, located in the receiver openings are capable of injecting calculated amounts of balancing fluid into particular portions of the inner tub.

The invention provides a relatively simple, inexpensive unbalance correction system which is able to accurately remedy an out-of-balance condition sensed by an unbalanced detection assembly. In any event, additional objects, features and advantages of the invention will become more readily apparent from the following detailed description of a preferred embodiment of the invention, when taken in conjunction with the drawings wherein like reference numerals refer to corresponding parts in the several views.

### BRIEF DESCRIPTION OF THE DRAWINGS

FIG. 1 is a plan view of a laundry appliance incorporating an on-axis injection system constructed in accordance with the present invention;

FIG. 2 is an exploded view of an outer tub portion of the laundry appliance of FIG. 1, showing a balancing fluid and delivery system for the on-axis injection system of the present invention;

FIG. 3 is an exploded view of an inner tub assembly depicting rear injection plane fluid receiving pockets for the on-axis injection system of the present invention;

FIG. 4 is a perspective view of a back plate of the inner tub assembly of FIG. 3 constructed in accordance with a preferred embodiment of the present invention;

FIG. 5 is a perspective view of the inner tub of FIG. 3 depicting front injection plane fluid receiving pockets arranged in accordance with a preferred embodiment of the present invention;

FIG. 6 is a partial cross-sectional view of the on-axis injection system, showing a balancing fluid injector valve and injector nozzle assembly arranged in accordance with the present invention;

FIG. 7 is an exploded view of the balancing fluid injector valve of FIG. 6;

FIG. 8 is a perspective view of an outlet portion of the balancing fluid injector valve of FIG. 7;

FIG. 9 is a another perspective view of the outlet portion of the balancing fluid injector valve;

FIG. 10 is a perspective view of a solenoid valve coil of the balancing fluid injector valve of FIG. 7, showing a plunger receiving base and associated pole piece;

FIG. 11 is a perspective view of the nozzle assembly incorporated in the on-axis injection system of FIG. 6; and

FIG. 12 is a partially exploded, detail view of a hub portion of the outer tub, showing a preferred mounting arrangement of the nozzle assembly of FIG. 10.

### DETAILED DESCRIPTION OF THE PREFERRED EMBODIMENT

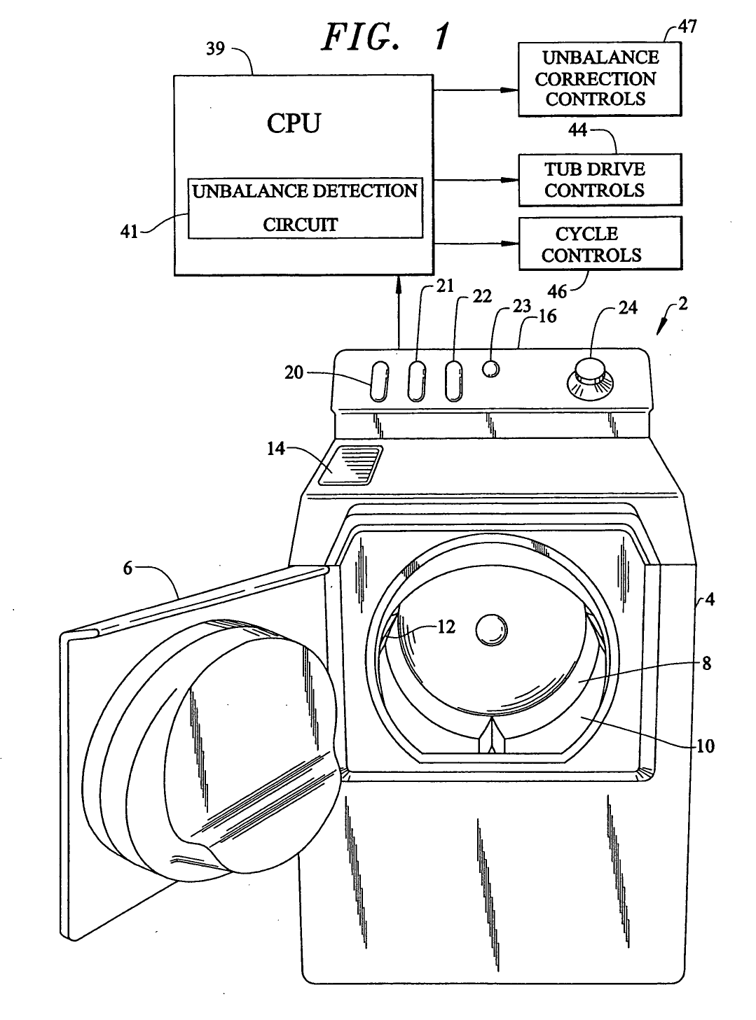

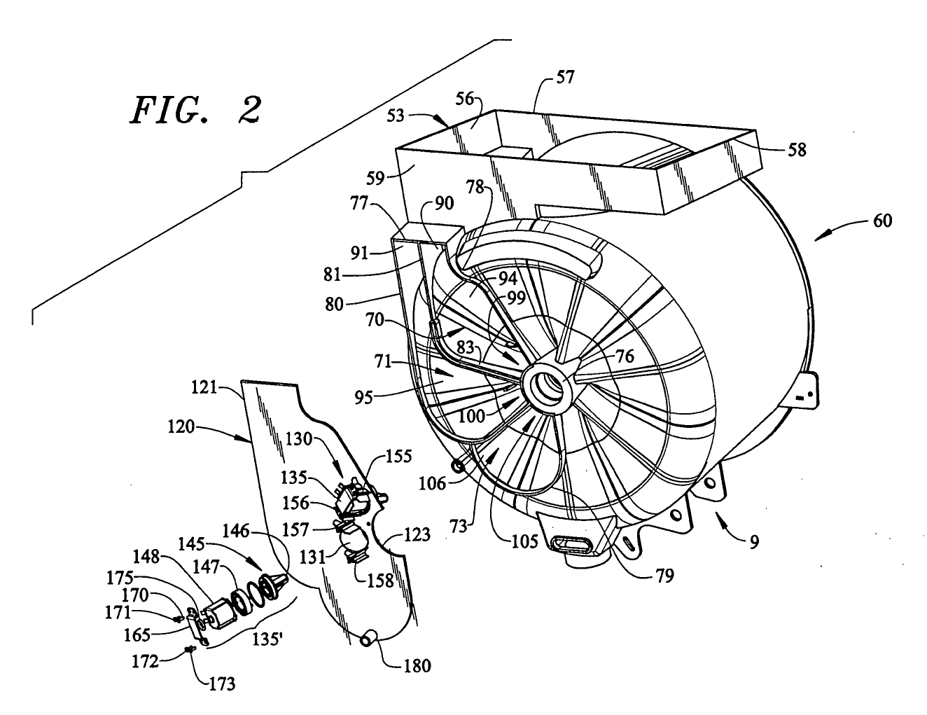

With initial reference to FIG. 1, a laundry appliance constructed in accordance with the present invention is generally indicated at 2. As shown, laundry appliance 2 constitutes a horizontal axis machine including an outer cabinet shell 4 having an associated door 6 which can be selectively opened to expose a washing basket 8. In the embodiment shown, washing basket 8, also referred to as an inner tub or spinner, is mounted within an outer tub 9 (FIG. 2) in cabinet shell 4 for rotation about an axis which is angled slightly downward toward a rear portion of cabinet shell 4. For the sake of completeness, inner tub 8 is shown to include a plurality of holes 10, as well as various generally triangular shaped and radially inwardly projecting fins or blades 12 which are fixedly secured to an internal peripheral portion of inner tub 8. In a manner known in the art, inner tub 8 is adapted to rotate during both wash and rinse cycles, such that articles of clothing placed therein actually tumble through either a water/detergent solution or rinse water supplied within inner tub 8. Water for the selected operation is actually contained within outer tub 9 in a manner known in the art. For the sake of completeness, laundry appliance 2 is also shown to include an upper cover 14 for providing access to an area for adding detergent, bleach, softener and the like.

In accordance with one embodiment of the present invention, laundry appliance 2 is shown to include a control panel 16 arranged on an upper rear portion of cabinet shell 4. In the embodiment depicted, control panel 16 includes a plurality of cycle setting buttons 20-22, a start/stop button 23 and a rotary control knob 24. Buttons 20-22 and control knob 24 are utilized to establish a desired washing operation for laundry appliance 2. Since the general setting and operating of laundry appliance 2 is known in the art and does not form part of the present invention, these features will not be discussed here in detail. However, in general, buttons 20-22 are used to manually set desired operational parameters, including a desired fill level based on load size, wash and rinse temperatures, along with the type of washing operation, such as gentle, normal or the like cycles, typically based on the particular fabrics being washed. On the other hand, control knob 24 is used to set the type and duration of the washing operation. Although control panel 16 is shown to include buttons 20-22, start button 23 and control knob 24, it should be understood that these particular types of control elements are merely intended to be exemplary and that other types of control elements, including electronic control elements, soft touch buttons, a touch screen LED panel and the like could be readily utilized.

Arranged within control panel 16 is a control unit or CPU 39. Control unit 39 includes unbalance detection circuit 41 for detecting actual or incipient unbalanced load conditions occurring within inner tub 8. Typically, during a spin cycle, a particular distribution of laundry within inner tub 8 may lead to an out-of-balance condition when inner tub 8 is rotated at high speed which can generate excessive vibrations of laundry appliance 2. It should be understood that, at this point the details of unbalance detection circuit 41 are not part of the present invention and can actually take various forms, such as that disclosed in commonly assigned U.S. Pat. No. 6,422,047 which is hereby incorporated by reference. In any case, unbalance detection circuit 41 receives signals from an unbalance detecting unit (not shown) and, depending on these signals, provides inputs to tub drive control 44, cycle control 46 and unbalance correction controls 47 which, in turn, provides the control to the on-axis injection system of the present invention as described more fully below.

Referring to FIG. 2, laundry appliance 2 preferably includes an on-axis injection system including a balancing fluid storage reservoir 53 having a plurality of side portions 56-59. More specifically, reservoir 53 is integrally molded to an upper region of outer tub 9. Furthermore, a top portion or cover (not shown) extends over side portions 56-59 enclosing reservoir 53 to prevent foreign objects from entering and contaminating the balancing fluid, as well as to prevent fluid loss. With this arrangement, an amount of balancing fluid, preferably in the range of 1-2 gallons, is stored within reservoir 53, with a portion of the balancing fluid being selectively delivered to inner tub 8 upon the detection of an out of balance condition. That is, reservoir 53, inner tub 8 in addition to feed and return conduits (not shown) form at least a portion of a closed balancing fluid containment system so that once filled, additional balancing fluid need never be added to the system. Preferably, the balancing fluid is a mixture of water and a propylene or ethylene glycol solution. More preferably, the balancing fluid is a mixture of water and a salt or calcium chloride solution, or other substances having similar qualities.

In accordance with a preferred embodiment of the present invention, the balancing fluid is delivered to inner tub 8 through a plurality of fluid delivery or receiving channels which are, at least partially, molded onto a rear portion 60 of outer tub 9. More specifically, as will be detailed more fully hereafter, first and second fluid delivery channels 70 and 71 carry the balancing fluid from reservoir 53 to particular pockets carried by inner tub 8. A third, drain or return channel 73 is further provided on rear portion 60 of outer tub 9 to collect expended balancing fluid from inner tub 8 and ultimately carry the fluid back to reservoir 53 through a hub portion 76. As shown, a plurality of raised wall portions 77-81 extend from hub portion 76 and thereafter separate and define each of the first, second and third channels 70, 71 and 73. Furthermore, in order to reduce the possibility of fluid leaking between first and second delivery channels 70 and 71, a segment of wall portion 81 includes a double wall segment 83. Finally, in addition to partitioning the fluid channels 70, 71 and 73, raised wall portions 77-81 and 83 increase the stiffness and thus the structural integrity of outer tub 9.

In accordance with a preferred arrangement, first and second fluid delivery channels 70 and 71 open to reservoir 53 at respective upper portions 90 and 91. From upper portions 90 and 91, balancing fluid delivery channels 70 and 71 extend along rear portions 94 and 95 of outer tub 9 before opening to delivery channels 99 and 100 at hub portion 76. Preferably, rear portions 94 and 95 are formed with a minimal number of undulations or the like which could lead to inconsistency in balancing fluid delivery. Similarly, a drain opening 105 leads from hub portion 76 to an upper or inner radial portion of drain channel 73. As will be detailed more fully below, as the balancing fluid returns from inner tub 8, it passes along hub portion 76 to drain opening 105 traveling along a rear portion 106 prior to being returned to reservoir 53 as will be discussed more fully below.

In order to ensure the existence of a proper pressure head, as well as to fully close off the delivery system, a cover plate 120 is secured to raised wall portions 77-81 and 83 on outer tub 9. As shown, cover plate 120 is defined by an outer contour 121 corresponding to raised wall portions 77-81 and includes a notched portion 123 adapted to partially extend about hub portion 76. As further shown in FIG. 2, arranged on cover plate 120 are first and second cylindrical receivers 130 and 131. More specifically, cylindrical receivers 130 and 131 are positioned at delivery channels 70 and 71 in order to position one of a pair of balancing fluid injector valves, which are indicated at 135 and 135′, within delivery channels 99 and 100 respectively.

Although further details of injector valve assemblies 135 and 135′ will be provided hereafter, in general, each of injector valve assemblies 135 and 135′ includes at least an outlet or base portion 145 having a curvilinearly tapered end portion 146 adapted to matingly seat in a respective outlet delivery channel 99 and 100, an intermediate portion 147 and a valve coil 148. Most preferably end portion 146 evinces a generally spherical profile that has been truncated. In a preferred form of the invention, injector valve assemblies 135 and 135′ are secured within respective cylindrical receivers 130 and 131 through a plurality of raised mounting lugs 155-158 arranged adjacent to each cylindrical receiver 130, 131. More specifically, injector valve assemblies 135 and 135′ are secured to mounting lugs 155-158 through respective bracket members 165 by a plurality of mechanical fasteners 170-173. In a more preferred form, a resilient ring 175 is positioned between valve coil 148 and mounting bracket member 165 to account for any excessive vibrations or misalignment problems with respect to injector assemblies 135 and 135′ within outlet delivery channels 99 and 100.

Opening from a lower portion of cover plate 120 is a drain conduit 180 which directs returning balancing fluid from drain channel 73 to reservoir 53. In accordance with a preferred embodiment of the present invention, drain conduit 180 interconnects to reservoir 53 through a pump (not shown) which functions to return the balancing fluid from drain channel 73 to reservoir 53. In accordance with another embodiment of the present invention, drain conduit 180 interconnects with an intermediate sump and pump (not shown) adapted to store the used balancing fluid until demanded through correction controls 47. In any event, it is only important to note that the balancing fluid is preferably returned to reservoir 53 in a manner so as to define a closed system. In this way, there is no further need to add balancing fluid once laundry appliance 2 leaves the factory.

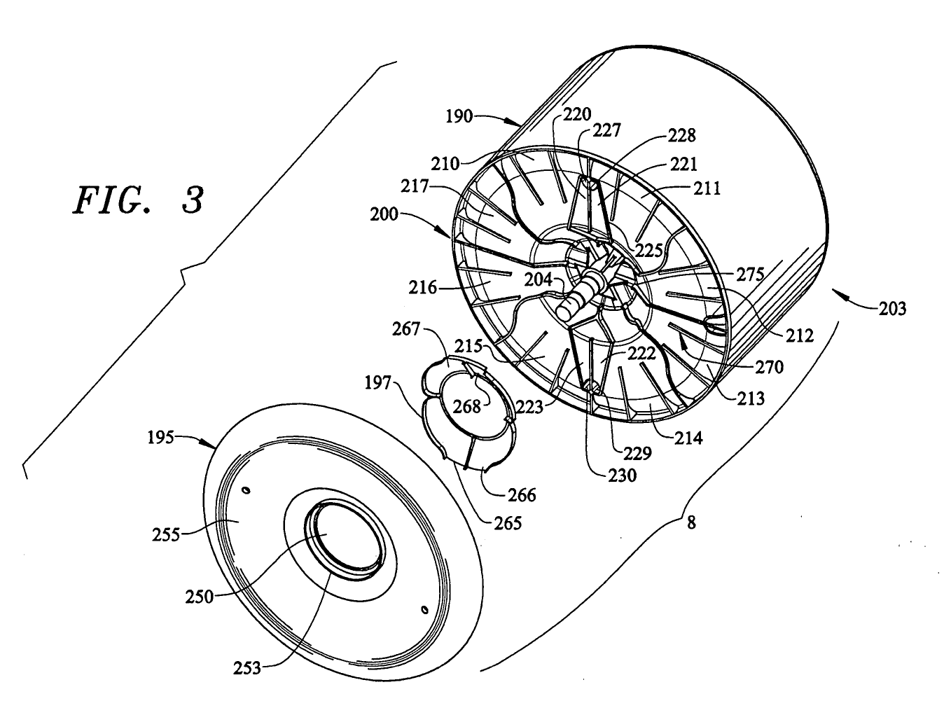

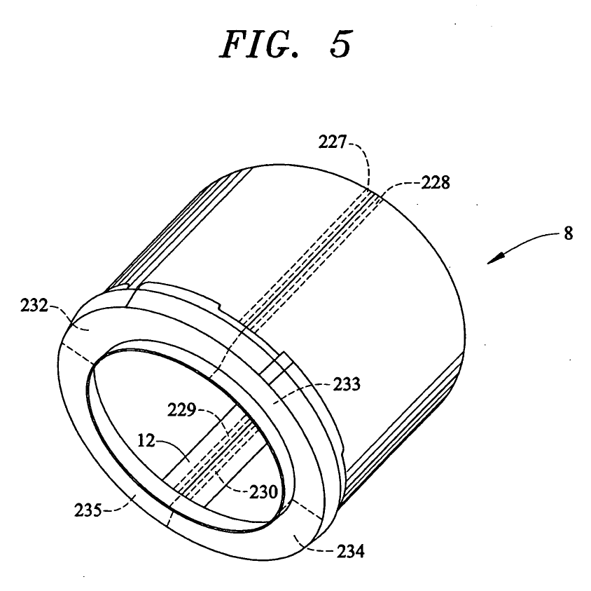

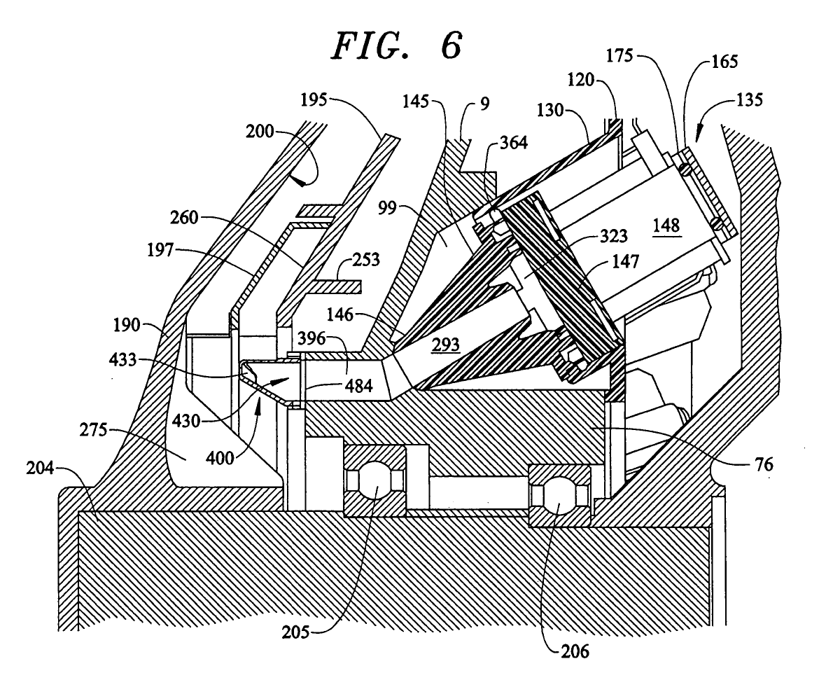

Referring to FIG. 3, the on-axis injection system is primarily carried by inner tub 8. In the embodiment shown, inner tub 8 includes a cylindrical spinner body member 190, a back or cover plate 195 and a diverter plate 197 sandwiched therebetween. Spinner body member 190 is preferably formed with a first end defining a rear injection zone 200 and a second end or front injection zone 203. As will be discussed more fully below, a shaft member 204 rotatably supports inner tub 8 within sealed bearings 205-206 (FIG. 6). A first plurality of balancing fluid receiving receptacles or rear injection plane pockets 210-217 are arranged about rear injection zone 200. Each of the plurality of rear injection plane pockets 210-217 is partially defined by a first plurality of raised wall portions, one of which is indicated at 215. In a similar manner, a plurality of front plane diverter channels indicated at 220-223 are partially defined by a second plurality of raised wall portions, one of which is shown at 225. More specifically, front plane diverter channels 220-223 respectively lead to front plane passages 227-230 which, in turn, fluidly interconnect front plane diverter channels 220-223 with a plurality of front plane injection pockets 232-235 (FIG. 5) through respective ones of blades 12.

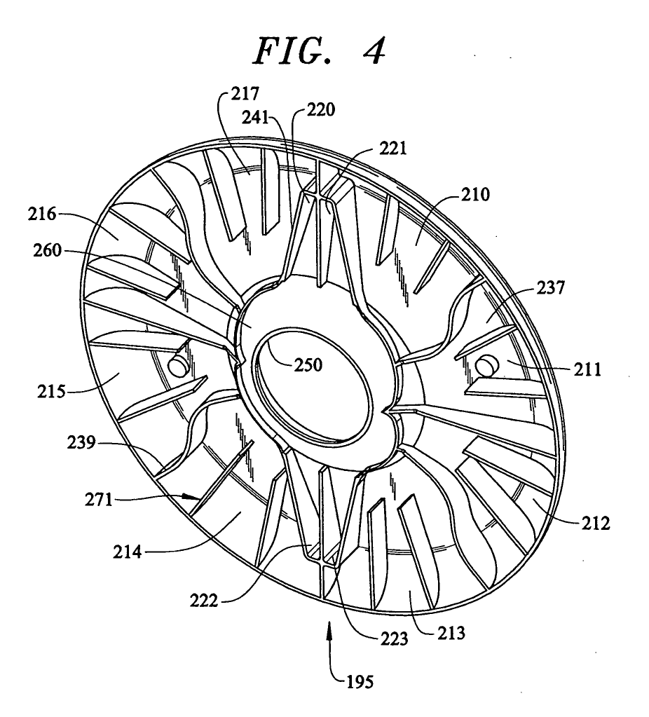

Rear portion 200 of spinner body member 190 is closed off by cover plate 195. As best seen in FIG. 4, cover plate 195 includes an inner surface 237 having a plurality of first and second raised wall portions, such as those generally indicated at 239 and 241. In this manner, each of the plurality of rear plane pockets 210-217 and front plane channels 220-223 are isolated one from the other. Additionally, cover plate 195 includes a central opening 250 having a raised rim 253 located on an outer surface 255 (FIG. 3) and an inner contour 260 arranged adjacent to central opening 250 on inner surface 237 (FIG. 4). Inner contour 260 is formed so as to receive diverter plate 197. Referring to FIG. 3, diverter plate 197 includes a plurality of raised portions (not separately labeled) which define a plurality of front panel pathways 265-268 that communicate with channels 220-223.

Referring to FIGS. 3 and 4, rear portion 200 of spinner body member 190 and inner surface 237 of cover plate 195 include a plurality of raised, baffle portions indicated generally at 270 and 271. As shown, raised portions 270 and 271 are provided within rear plane pockets 210-217 as well as front plane channels 220-223, and are spaced from both central opening 250 and a central recess 275 of spinner body member 190. Raised portions 270 and 271 form baffles that discourage the sloshing of fluid within rear plane pockets 210-217 and front plane channels 220-223 when spinner body member 190 is revolving at a low rpm. Raised portions 270 and 271 include passages and/or holes (not separately labeled) at the periphery of spinner body member 190 that allow water to flow slowly between volumes formed by raised portions 270 and 271 when cover plate 195 is attached to spinner body member 190. It is desirable to have between 1 and 5 raised portions 270, 271 in each rear plane pocket 210-217 and front plane channel 220-223. The passages through each raised portion 270, 271 should have an area equivalent to round holes of between 1/8 inch and 2 inches in diameter to provide adequate water flow between each rear plane pocket 210-217 and front plane channel 220-223. The most preferred number of baffles is three and the most preferred area is about ¼″ equivalent diameter. Similar baffles (not shown) are incorporated into the front plane injection pockets 232-235.

With this arrangement, balancing fluid can be dispensed into any combination of rear and front plane pockets 210-217, 232-235 to compensate for an out-of-balance condition of rotating inner tub assembly 8. With specific reference to FIGS. 2, 3, 5 and 6, dispensing a dollop of balancing fluid between diverter plate 197 and cover plate 195 near shaft member 204 forces the balancing fluid into one of the plurality of front plane channels 220-223 which lead to passages 227-230 and ultimately to front injection zone 203. Conversely, dispensing a dollop of balancing fluid between diverter plate 197 and rear zone 200 near shaft member 204 forces the balancing fluid into one of the plurality of rear plane pockets 210-217. The particular pocket 210-217, 232-235 into which the dollop will fall is based on both the sensed need for correction, the injector 135, 135′ activated, and the timing of the injection. At this point, it should be realized that the actual number of front or rear pockets employed could be varied in accordance with the invention, with the preferred range being between 3 and 12. In any case, by dispensing the dollop of balancing fluid near shaft member 204, the dollop will contact inner tub 8 at a point of low velocity to minimize splash in order to increase the accuracy of the injection.

As will be detailed more fully below, once inner tub assembly 8 ceases to spin, the need for balancing fluid in either rear injection zone 200 or front injection zone 203 is eliminated. Accordingly, as the radial velocity of inner tub 8 decreases, so does the centrifugal force holding the balancing fluid within a particular pocket 210-217 and 232-235. As the force continues to decrease, the balancing fluid begins to migrate to shaft member 204 and collect in recess 275 (FIGS. 3 and 6) as each respective pocket 210-217 and 232-235 passes a top point of rotation. Once tub assembly slows sufficiently, the balancing fluid travels along shaft member 204 to drain channel 73 and ultimately returns to reservoir 53.

Upon sensing an actual or incipient out-of-balance condition, correction controls 47 signals the on-axis injection system to dispense an out-of-balance correcting balancing fluid into particular portions of inner tub assembly 8. In order to offset the out-of-balance condition, correction control 47 determines into which plane and into which pocket in that plane an injection of balancing fluid is required. At this point, a timing mechanism (not shown) timely activates one of the pair of injectors 135 and 135′ corresponding to the particular injection zone 200 and 203 into which an injection of fluid is necessary. Reference will now be made to FIGS. 6-9 in describing the preferred construction of injectors 135 and 135′. Since the structure of each injector 135, 135′ is identical, a description of injector 135 will be made and it is to be understood that injector 135′ has commensurate structure.

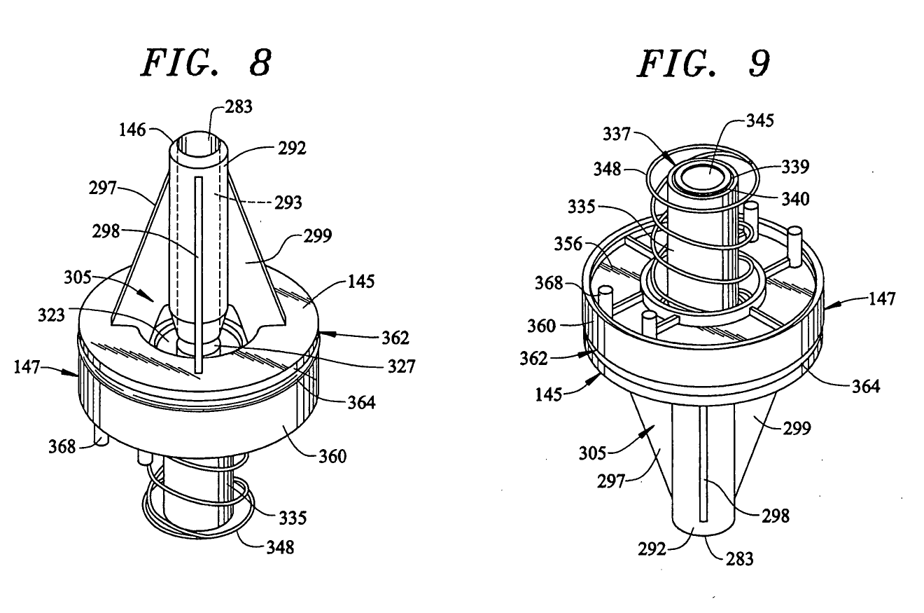

In accordance with a preferred embodiment as discussed above, injector 135 takes the form of a solenoid type valve and includes base portion 145 having curved or tapered end portion 146, an intermediate portion 147 and valve coil 148. More specifically, end portion 146 includes a first end defining an outlet opening 283 and a second end having an inner surface portion 286 defining a central recess 288. Extending between outlet opening 283 and an inlet opening 290 is a delivery conduit 292 having a central passage 293. Preferably, delivery conduit 292 is integrally molded to base portion 145 and includes a plurality of tapering rib elements 297-299. More specifically, rib elements 297-299 support delivery conduit 292 and define a balancing fluid inlet or supply opening 305 (FIG. 8). Finally, as will be detailed more fully below, a plurality of locating holes, one of which is indicated at 309, are arranged about inner surface portion 286.

In accordance with the preferred embodiment shown, inlet opening 290 is adapted to be selectively sealed through application of a diaphragm 319 positioned along inner surface portion 286. More specifically, diaphragm 319 includes surface 323 which extends into and seals about central recess 288. As best seen in FIG. 8, a sealing member 327 is centrally arranged on surface 323 and positioned to selectively close off inlet opening 290 through axial movement of a plunger 335 which is fixed to diaphragm 319.

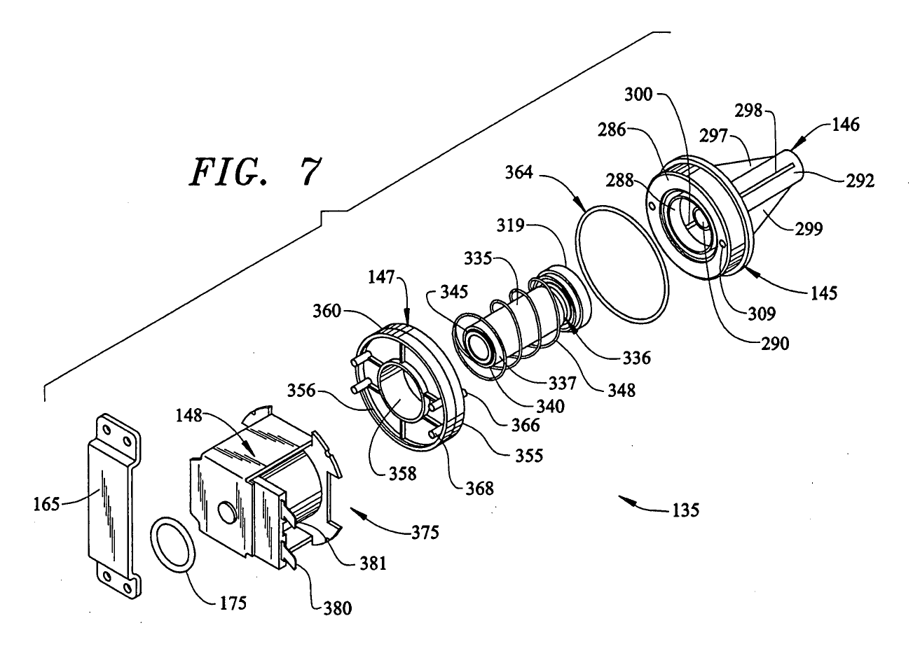

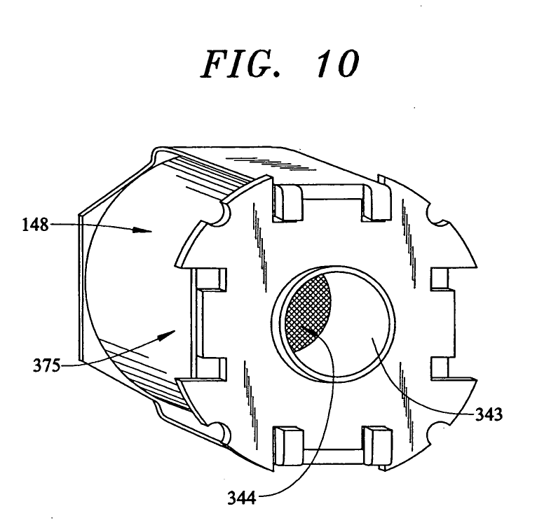

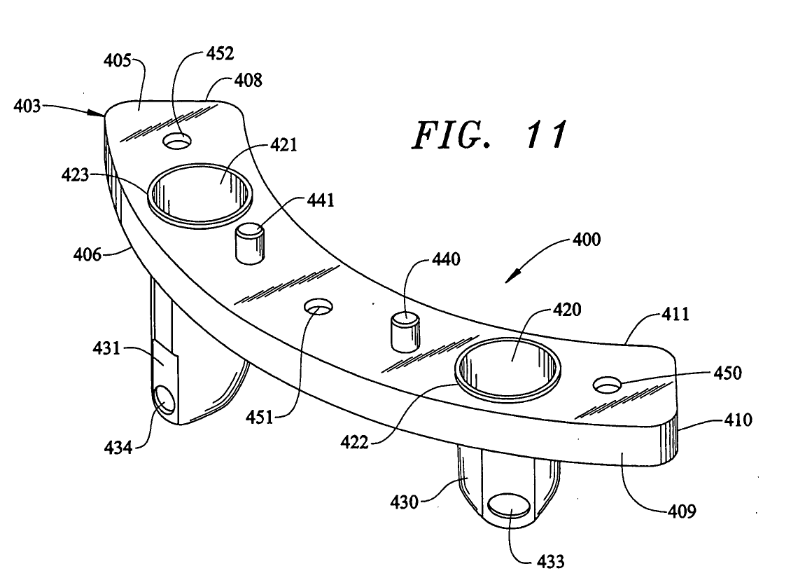

More specifically, as best shown in FIG. 7, plunger 335 includes a first end portion 336 interconnected to diaphragm 319, and a second end portion 337. As best seen in FIG. 9, second end portion 337 includes an annular notch or groove 339 within which is arranged a cushioning ring 340. Cushioning ring 340 is provided to reduce the effects on valve assembly 135 from the repeated cycling of plunger 335. In a typical solenoid valve operation, plunger 335 is drawn into a cylindrical bore 343 that extends within valve coil 148 (FIG. 10). Each time plunger 335 enters bore 343, second end 337 of plunger 335 is forced against a pole piece or end stop 344.

Experience has shown that repeated operation of the valve results in wear to both second end 337 and pole piece 344 causing the calibration of valve assembly 135 to exceed manufacturer specifications. However, by incorporating cushioning ring 340 into second end portion 337, the life of valve assembly 135 can be extended such that prolonged operation is possible. In addition, cushioning ring 340 helps control the physical profile of the balancing fluid dollop as it passes from outlet 283. Because of the critical role that cushioning ring 340 plays in the performance of valve assembly 135, it would generally be considered desirable to have pole piece 344 as smooth as possible to minimize wear on cushioning ring 340. However, each time cushioning ring 340 contacts pole piece 344, an amount of air is trapped within a center portion 345 of cushioning ring 340. Because the force between pole piece 344 and plunger 335 becomes large as plunger 335 approaches pole piece 344, the pressure of the trapped air can become high and air may leak from the center of cushioning ring 340 in an uncontrolled manner.

When the electrical power to valve coil 148 is removed, plunger 335 moves away from pole piece 344. If air has leaked from the center of cushioning ring 340, then a vacuum may be drawn within cushioning ring 340 to retard or prevent the movement of plunger 335, which undesirably changes the amount and location of the injected fluid. In order to alleviate the problem of trapped air, pole piece 344 is subject to a texturing process wherein the surface of pole piece 344 is formed with channels, notches, grooves, or the like. With this arrangement, trapped air can escape from center portion 345, thereby enabling plunger 335 to fully retract into bore 343 without excessive pressure build-up. Further, the texturing provides a path for air to reenter center portion 345 as plunger 335 is released so that vacuum does not retard plunger motion. It should be understood that a polished pole piece may work satisfactorily for some applications, but where cycle-to-cycle consistency is desired, a roughened or textured pole piece 344 offers more consistent performance. Finally, a coil spring 348 is arranged about plunger 335 to bias diaphragm 319 against inlet opening 290 during periods of inactivity.

With further reference to FIGS. 7-9, intermediate portion 147 of valve assembly 135 has a first side surface 355 and a second side surface 356 between which extends a central opening 358. More specifically, first and second side surfaces 355 and 356 are surrounded by a cylindrical side wall portion 360. Intermediate portion 147 is fitted to base portion 145 with an annular notch or groove 362, which is adapted to receive a sealing ring 364, being defined between base portion 145 and cylindrical side wall portion 360. Actually, sealing ring 364 projects radially outwardly of cylindrical side wall portion 360. With this arrangement, sealing ring 364 maintains a fluid tight seal about injector 135 within cylindrical receiver 130 (FIG. 6). Therefore, valve assembly 135 will seat within receiver 130 despite differences resulting from manufacturing tolerances. In the embodiment shown, sealing ring 364 constitutes a resilient O-ring, however, it should be understood that various ring profiles can be used to obtain the same result. In addition, arranged on first side surface 355 are a first plurality of locating pins, one of which is indicated at 366. Each locating pin 366 is adapted to extend into a respective locating hole 309 of base portion 145 for positioning intermediate portion 147 in a particular alignment with base portion 145. Similarly, a second plurality of locating pins 368 project from second side surface 356. The second plurality of locating pins 368 are adapted to engage into a respective notch portion 375 (FIG. 10) on valve coil 148 to maintain a particular alignment between intermediate portion 147 and valve coil 148.

Valve assemblies 135 and 135′ are selectively activated though application of voltage to electrical terminals 380 and 381 (FIG. 7) of valve coil 148. Referring to FIGS. 3 and 6, upon determining into which injection zone 200 or 203 and, more importantly, into which pocket(s) 210-217, 232-235 in that zone the balancing fluid is to be injected, control 47 times the activation of a particular injector 135, 135′ to deliver the balancing fluid necessary to offset the out-of-balance condition. Upon activation, plunger 335 is drawn into valve coil 148 exposing inlet opening 290 to a flow of balancing fluid from supply opening 305. In a preferred form of the invention, the voltage applied to activate valve coil 148 is ramped, which enables greater control over the movement of plunger 335 and, by extension, the amount of fluid dispensed. In any event, the balancing fluid travels through central passage 293, passes from outlet opening 283 and flows through a respective gap or passage, one of which is indicted at 396, into a nozzle assembly 400 which dispenses the balancing fluid into the desired pocket 210-217 or 232-235. Preferably passage 396 is in the range of ¼″-1″ and, more preferably, from ⅜″-½″.

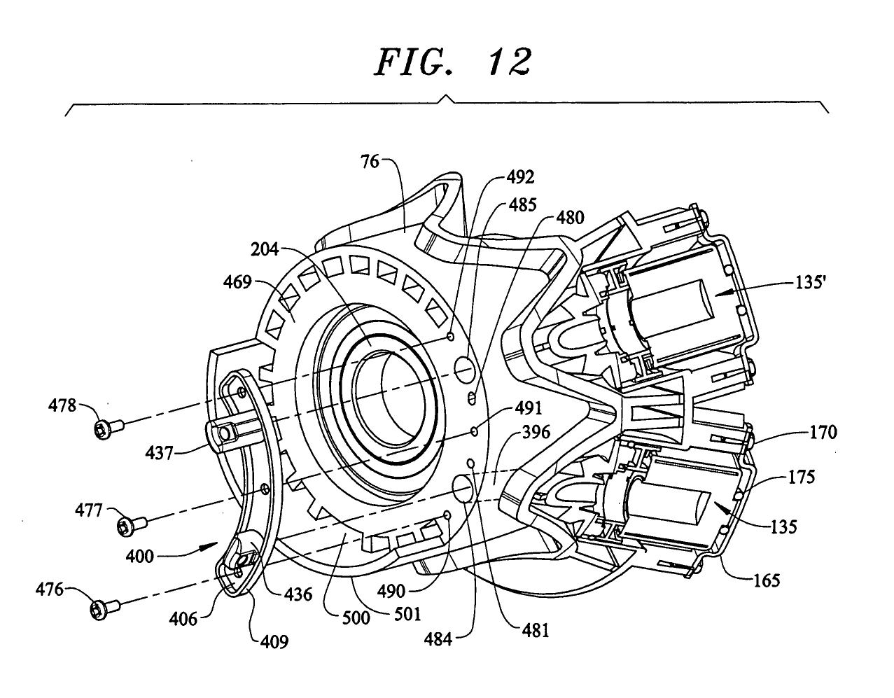

As best seen in FIG. 11, nozzle assembly 400 is defined by an arcuate main body portion 403 having a first surface 405, an opposing second surface 406 and surrounding side surface portions 408-411. In accordance with a preferred form of the present invention, first and second fluid inlet ports 420 and 421, each having a respective raised side portion 422 and 423, are arranged on first surface 405. More specifically, raised side portions 422 and 423 provide a flange which help locate nozzle assembly 400 on hub 76 and further assist in sealing nozzle assembly 400 to passage 396. Inlet ports 420 and 421 open to respective nozzle elements 430 and 431, each having an outlet 433, 434 which extends from second surface 406 into a respective front or rear injection zone 203 or 200 respectively. Each outlet 433, 434 opens substantially perpendicular to a respective passage 396 and defines a sharp internal edge orifice (not separately labeled) which enables the low pressure system to cause a particular dollop of balancing fluid to remain cohesive when being dispensed. In addition, this arrangement also causes each dollop to have a clean break on the back portion thereof and minimizes follow-on droplets which could reduce the accuracy of the injection and may result in water placement outside a desired pocket 210-217, 232-235. The internal edges of passages 423 and 434 are considered sharp when their length perpendicular to passage 396 is less than ⅛″, preferably less then 1/16″ and, most preferably, less than 0.030″. The sharp internal edge of passages 423 and 434 preferably have a radius of up to 0.010″. Finally, as will be detailed more fully below, nozzle assembly 400 includes a pair of locating pins 440 and 441, as well as a plurality of mounting apertures 450-452 arranged along first surface 405.

Referring to FIG. 12 which depicts a preferred mounting arrangement of the present invention, nozzle assembly 400 is secured to an inner surface 469 of hub portion 76 through a plurality of mechanical fasteners 476-478. As shown, a corresponding pair of locating holes 480 and 481 are arranged along a portion of inner surface 469 to receive a respective locating pin 440, 441 which position and align nozzle inlets 420 and 421 with respective outlets 484 and 485. Fasteners 476-478 are actually received in a plurality of threaded bores 490-492 provided on inner surface 469.

Upon sensing an unbalanced condition of inner tub 8, unbalance detection circuit 41 in CPU 39 determines the magnitude and location of the unbalanced condition. At this point, correction control 47 calculates the amount of balancing fluid, and into which one of the plurality of pockets 210-217 and 232-235 to inject the balancing fluid to offset the unbalanced condition. More specifically, a timing mechanism (not shown) monitors the position of the inner tub 8 relative to injectors 135 and 135′. Through use of the timing mechanism, unbalance correction control 47 operates the appropriate one of injectors 135 and 135′, at a proper time and for a desired duration, to dispense the calculated amount to fluid into the requisite pocket 210-217, 232-235. Centrifugal force, generated by rotating inner tub 8, forces the balancing fluid into the appropriate one of the plurality of pockets 210-217, 232-235. This process repeats itself until the unbalance condition is corrected as sensed by unbalance detection circuit 41. As indicated above, once the centrifugal force keeping the balancing fluid within the particular pocket 210-217, 232-235 diminishes sufficiently, the balancing fluid, under force of gravity, returns to drain channel 73. As shown in FIG. 12, this return flow is accomplished with an inner surface 469 of hub portion 76 being provided with at least one return port indicated at 500. In this manner, the balancing fluid is ultimately returned to reservoir 53 for continued use as required by unbalance control 47.

As shown in FIG. 12, injectors 135 and 135′ are located on one side of hub portion 76. Although the precise location of injectors 135 and 135′ is not critical, it is important that they be placed on the side of machine 2 where the spinner rotation produces a downward motion. In this way, the balancing fluid is injected at a location where the maximum time is available for the fluid flow to the periphery of spinner 8 before the appropriate pocket 210-217, 232-235 passes over the top of machine 2. If nozzles 135 and 135′ are not placed on the downward moving side, some fluid may not traverse to the outside of spinner 8 where centrifugal force is maximum and may fall back out of a respective pocket 210-217, 232-235 when spinner 8 is moving more slowly, such as during an initial balance process.

Although described with reference to a preferred embodiment of the invention, it should be readily understood that various changes and/or modifications can be made to the invention without departing from the spirit thereof. For instance, the exact construction and location of the reservoir could vary without departing from the scope of the present invention. In general, the invention is only intended to be limited by the scope of the following claims.

1. A washing machine comprising:
a cabinet shell;
an outer tub mounted within the cabinet shell, said outer tub including a rear wall portion, a central hub portion and a main body portion defining an interior cavity;
an inner tub supported for rotation within the interior cavity of the outer tub, said inner tub including a plurality of balancing fluid receiving pockets;
a balancing fluid reservoir connected to the main body portion at an upper region of the outer tub; and
at least one balancing fluid channel leading from the reservoir to the plurality of balancing fluid receiving pockets for delivering balancing fluid to select ones of the balancing fluid receiving pockets.

2. The washing machine according to claim 1, wherein the balancing fluid reservoir is integrally molded to the main body portion of the outer tub.

3. The washing machine according to claim 2, wherein the balancing fluid reservoir is integrally molded to an upper surface of the main body portion and projects above the main body portion.

4. The washing machine according to claim 1, wherein the at least one balancing fluid channel constitutes first and second delivery channels and a return channel, each of said first and second delivery channels and said return channel being, at least in part, integrally formed along the rear wall portion of the outer tub.

5. The washing machine according to claim 4, further comprising: a plurality of raised wall portions extending between and separating the first and second delivery channels and the return channel.

6. The washing machine according to claim 5, wherein at least the raised wall portion extending between the first and second delivery channels is constituted by a double wall portion.

7. The washing machine according to claim 5, further comprising: a cover plate adapted to extend over and seal the first and second delivery channels and the return channel though the raised wall portions.

8. The washing machine according to claim 7, further comprising:
first and second receiver openings extending through the cover plate adjacent to the central hub portion.

9. The washing machine according to claim 8, further comprising:
first and second injector valves mounted in the first and second receiver openings.

10. The washing machine according to claim 9, further comprising: a plurality of mounting bosses carried by the cover plate about each of the first and second receiver openings, said plurality of mounting bosses being adapted to receive first and second retaining members for securing the first and second injector valves in the first and second receiver openings respectively.

11. The washing machine according to claim 1, further comprising: an amount of balancing fluid at least partially contained within the balancing fluid reservoir, said amount of balancing fluid being formed from a composition of water and at least one substance selected from the group consisting of: calcium chloride, propylene glycol or ethylene glycol.

12. The washing machine according to claim 1, wherein the balancing fluid reservoir, at least one balancing fluid channel and the plurality of balancing fluid receiving pockets form part of an overall closed balancing fluid containment system.

13. An outer tub for a washing machine including a rear wall portion, a central hub and a main body portion comprising:
a balancing fluid reservoir connected to the main body portion at an upper region of the outer tub; and
at least one balancing fluid channel leading from the reservoir.

14. The outer tub according to claim 13, wherein the balancing fluid reservoir is integrally molded to the main body portion.

15. The outer tub according to claim 14, wherein the balancing fluid reservoir is integrally molded to an upper surface of the main body portion and projects above the main body portion.

16. The outer tub according to claim 13, wherein the at least one balancing fluid channel constitutes first and second delivery channels and a return channel, each of said first and second delivery channels and said return channel being, at least in part, integrally formed along the rear wall portion.

17. The outer tub according to claim 16, further comprising: a plurality of raised wall portions extending between and separating the first and second delivery channels and the return channel.

18. The outer tub according to claim 17, wherein at least the raised wall portion extending between the first and second delivery channels is constituted by a double wall portion.

19. The outer tub according to claim 13, further comprising: an amount of balancing fluid at least partially contained within the balancing fluid reservoir, said amount of balancing fluid being formed from a composition of water and at least one substance selected from the group consisting of: calcium chloride, propylene glycol or ethylene glycol.

20. The outer tub according to claim 13, wherein the balancing fluid reservoir, at least one balancing fluid channel and a plurality of balancing fluid receiving pockets form part of an overall closed balancing fluid containment system.

21. A method of forming an outer tub of a washing machine comprising:
creating a substantially cylindrical main body portion having an end which is at least substantially closed by a rear wall portion having an associated central portion;
providing a balancing fluid reservoir at an upper region of the main body portion;
forming at least one balancing fluid delivery channel along the rear wall portion of the outer tub, with the at least one balancing fluid delivery channel extending radially toward the central portion; and
fluidly interconnecting the balancing fluid reservoir and the at least one balancing fluid delivery channel.

22. The method of claim 21, further comprising: forming at least one passage leading from the at least one balancing fluid delivery channel through the main body portion adjacent the central portion.

23. The method of claim 21, further comprising: forming a return channel for the balancing fluid along the rear wall portion.

24. The method of claim 21, further comprising: integrally molding the balancing fluid reservoir and the outer wall portion.

25. The method of claim 21, further comprising: forming a balancing fluid from a mixture of water and at least one substance selected from the group consisting of: calcium chloride, propylene glycol or ethylene glycol.

26. The method of claim 21, further comprising: forming a closed balancing fluid containment system including at least the balancing fluid reservoir, said at least one balancing fluid delivery channel and a plurality of balancing fluid receiving pockets.
